(19) United States
(12) Patent Application Publication
(10) Pub. No.: US 2015/0235309 A1
(43) Pub. Date: Aug. 20, 2015

(54) BUSINESS SERVICES PLATFORM SOLUTIONS FOR SMALL AND MEDIUM ENTERPRISES

(71) Applicant: MasterCard International Incorporated, Purchase (NY)

(72) Inventors: Sandeep Malhotra, Singapore (SG); Rajen S. Prabhu, Singapore (SG); Prashant Sharma, Singapore (SG); Jiaming Li, Singapore (SG); Jie Zhang, Singapore (SG)

(73) Assignee: MasterCard International Incorporated, Purchase, NY (US)

(21) Appl. No.: 14/183,829

(22) Filed: Feb. 19, 2014

(51) Int. Cl. G06Q 40/02; G06Q 20/34

(52) U.S. Cl. CPC G06Q 40/02; G06Q 20/34

(57) ABSTRACT

Methods and systems for providing business services solutions for small and medium enterprises (SMEs) owned by merchants in developed markets and in developing markets. In some embodiments, a merchant enrolls with a merchant issuer financial institution (FI) and then receives an SME financial account, a suite of shared SME business service applications, and access to a payment card acceptance service for use in setting up and scaling their business. In an implementation, the process includes receiving a request for an SME business platform, validating merchant identification data, providing an SME financial account to the merchant, transmitting an SME business platform acceptance message, and transmitting an SME business platform to the merchant device. The SME business platform includes a payment card account acceptance application and at least one business services application configured for running on the merchant device.

### FIELD OF THE DISCLOSURE

Embodiments disclosed herein generally relate to methods and systems for providing business services solutions for small and medium enterprises (SMEs) owned by merchants in developed markets and in developing markets. In some embodiments, a merchant enrolls with a merchant issuer financial institution (FI) and then receives an SME financial account (such as a business debit card account), a suite of shared SME business service applications, and access to a low cost payment card acceptance service for use in setting up and scaling their business.

### BACKGROUND

Payment card systems are in widespread use. A prominent payment card system is operated by the assignee hereof, MasterCard International Incorporated, and by its customer financial institutions. Typically, a purchase transaction initiated by a consumer with a payment card account in a developed market (such as the United States and/or Europe) occurs when the consumer visits a retail store operated by a merchant, selects goods that he or she wishes to purchase, carries the goods to the merchant's point-of-sale (POS) terminal, and presents his or her payment card. A reader device associated with the POS terminal is used to read the customer's payment card account number from the payment card, and then the POS terminal transmits an authorization request to a merchant acquirer financial institution (FI) with which the merchant has a relationship. The authorization request typically includes the consumer's payment card account number, the amount of the purchase transaction, and other data. The authorization request is routed via a payment card system (which may be, for example, the well-known Banknet™ system operated by MasterCard International Incorporated) to the issuer financial institution (FI) that issued the customer's payment card. If the consumer has adequate credit to cover the cost of the purchase, then the issuer FI authorizes the payment transaction and transmits a favorable authorization response through the payment card system and via the merchant acquirer FI to the POS terminal. The transaction at the POS terminal is then completed and the customer leaves the retail store with the goods.

The foregoing description of a typical consumer purchase transaction may be considered to be somewhat simplified in some respects. For example, a merchant processing system may be interposed between the POS terminal and the acquirer FI. As is familiar to those skilled in the art, such a merchant processing system may be operated by or on behalf of the merchant to form part of the communications path between the merchant acquirer FI and a considerable number of POS terminals operated by the merchant. In addition, a third party transaction processing service may be included, such as a payment services provider (PSP), which operates to handle payment card transactions on behalf of the acquirer FI and on behalf of a large number of other like financial institutions.

The purchase transaction apparatus and processes described above are typically utilized by large-scale merchants in developed markets, and may not be available to small and/or medium size business owners. Moreover, such purchase transaction systems are not typically available to small and medium business owners operating in developing markets. Thus, other types of card acceptance services have been developed for use by small to medium size businesses, which claim to be less costly and easier to use. For example, a service called “Square” enables businesses (principally small businesses and sole proprietorships) to accept card payments. A dongle is provided that must be attached to a mobile device such as an iPhone™ or Android™-type mobile telephone and configured for swiping payment cards, which enables a small business to accept magnetic stripe transactions and issue an electronic receipt. In particular, a consumer swipes his or her payment card through a slot provided in the dongle, and after an “authorizing” message is displayed, the consumer signs for the purchase by using the touch screen of the merchant's mobile device. In order to utilize the “Square” service, a small business owner contracts with the Square Company, which then provides underwriting, risk management, transaction processing and customer support functions. However, it has been recognized that the “Square” credit card processing service is not a good fit for every small business, and detractors have criticized the Square service as frustrating for users due to high deposit limits, frozen funds, and poor customer service.

The present inventors recognized that a need exists for a complete electronic business platform available to small and medium size business entities in developed and developing markets that functions to help them to improve their business processes (for example, to improve their cash register, inventory management, payments and collections, settlement, reconciliation, analytics, loyalty and rewards practices). In particular, the inventors recognized that there is a need for a Business-to-Business platform that can be easily obtained, that is inexpensive, easy to use, and that provides opportunities for adding value-added services which may be provided to consumers, merchants and/or financial institutions.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate exemplary embodiments and which are not necessarily drawn to scale, wherein:

FIG. 1 is a block diagram illustrating a small and medium enterprise (SME) processing system for small and/or medium size businesses operating in a developed market according to an embodiment of the disclosure;

FIG. 2 is a flowchart illustrating an SME enrollment process according to an embodiment of the disclosure;

FIG. 3 is a block diagram of a merchant device in the form of a POS terminal in accordance with some embodiments of the invention;

FIG. 4 is a block diagram illustrating an SME server computer according to an embodiment of the disclosure; and

FIG. 5 is a block diagram illustrating an alternative small and medium enterprise (SME) processing system for small and/or medium size businesses operating in a developing market according to an embodiment of the disclosure.

### DETAILED DESCRIPTION

Small and medium enterprise (SME) owners or merchants, who sell goods and/or services in retail locations and/or via the internet, recognize that an opportunity exists to improve and/or grow their businesses by using electronic cash acceptance systems and by obtaining and analyzing data pertaining to their business practices and customers in order to improve operations and/or save costs. An SME can be one of a micro-entity or micro-business, a small business, and/or a medium size business. A micro-business typically has one to ten employees, has annual revenues of less than one million dollars, has a balance sheet of less than one million dollars, and accepts cash and/or electronic funds transfers as payment for goods or services. A small business typically includes ten to fifty employees, has annual revenues of between one million and five million dollars, a balance sheet of less than ten million dollars, and accepts cash and/or electronic funds transfers as payment for goods or services. A medium business typically has from about fifty to about one hundred employees, has annual revenues of between about five million to ten million dollars, a balance sheet of less than ten million dollars, and accepts cash and/or electronic funds transfers and/or debit cards as payment for goods or services. Examples of SMEs include, but are not limited to, a restaurant and/or a cafe, a home delivery and/or e-commerce company, a transportation company (such as a taxi cab company and/or a limousine driver company), a handyman business, a personal services company, a doctors' office, a small law firm, a solo legal practitioner, a yoga instructor, a web designer or other type of consultant, a video game developer, a freelance writer, a personal trainer, fitness gyms, exhibition hall companies, local area fairs, and the like.

Merchants or owners of SMEs recognize that many consumers prefer to pay for items by using a credit card, debit card, and/or a payment-enabled mobile device, and therefore the capability to accept electronic payments is critical. Thus, SMEs are searching for a business management system and/or business platform that can provide them with a variety of payment acceptance options (for example, the capability to accept payment cards, cash, mobile wallet payments, and the like).

SMEs also crave information about their customers so that they can use that data to increase revenues. Thus, SMEs would like to automate their business processes and obtain information concerning customer behavior and insight into how their businesses and/or customers are changing and/or evolving. For example, in the current marketplace SMEs must be aware of current trends such as “showrooming,” which is a behavior some consumers practice of examining merchandise in a traditional retail store without purchasing it, and then shopping online to find a lower price for the same item (sometimes while still inside a retail store by using a smartphone). Such consumer behavior can be costly to SMEs, not only in terms of the loss of sales, but also due to damage caused by consumers handling the product floor samples in retail stores. Knowledge of such customer behavior can be a first step in designing solutions to combat the behavior and/or to turn such customer behavior to the advantage of SMEs. However, the cost for obtaining data and analyzing the data can be prohibitive for SMEs.

SMEs would also like to keep abreast of consumer trends, such as the use of “I am here”-type mobile applications currently in use by consumers that indicate that the consumer is in a particular location such as a particular retail store. Some large-scale merchants in developed markets have recognized this trend and have consequently invested in and provided multi-channel checkout experiences for such consumers. Such multi-channel checkout experiences may include, for example, determining that a particular consumer is utilizing an “I am here” application and then transmitting a discount coupon offer to that consumer for display on the consumer's mobile telephone while that consumer is still in the merchant's retail store location. However, because SMEs typically have limited budgets, they may not be able to afford to invest in the software and hardware components necessary to offer such multi-channel experiences (assuming that they even recognize such trends). But SMEs would still like to have the capability for offering such experiences to their customers to increase sales and/or to capture market share.

In general, presented herein are methods and systems to help SMEs set up and scale their businesses. In some embodiments, a merchant who is the owner of an SME enrolls with a merchant issuer financial institution (FI) for SME services, which may include business applications and/or services that are provided by a payment card network operator (such as MasterCard International Incorporated) as explained below. In some implementations, the SME owner or merchant undergoes background and credit checks instituted by the merchant issuer FI, and if all is in order, is provided with an SME financial account by the merchant issuer FI (such as a business debit card account and/or a business credit card account). In addition, the SME owner is provided with a suite of shared business services affiliated with the payment card network operator associated with the SME financial account. The shared business services may include a point of sale (POS) application, a low-cost card acceptance service, an inventory management application, an SME purchasing application, and one or more “Big Data” applications. “Big Data” is the term for a collection of data sets so large and complex that processing that data using on-hand database management tools or traditional data processing applications is difficult or impossible. Challenges include data capture, storage, search, analysis, and visualization of any analysis. Current business analytics applications utilize very large data sets to derive business information from a large set of related data, as compared to separate smaller data sets with the same total amount of data, allowing correlations to be found to, for example, spot business trends, determine quality of research, discover consumer trends and preferences, and provide other useful business information. For example, information about the merchant's business may be derived from other sources of data which can help a particular merchant increase their revenue and/or improve their business. For example, a “Big Data” application may operate to provide information concerning similar businesses in the same geographic area. The information may show that, for example, similar businesses improved revenues by 20% or more by providing home delivery, and/or have made an additional 2% or more in revenues by having business hours from 10 am to 6 pm (instead of from 9 am to 5 pm) each business day. Such business information is typically not made available to a micro-business, small business or medium business, and thus the SME services can aid a merchant in increasing revenues for his or her business and thus to fund expansion. In addition, the SME services are designed such that they can scale up as the business grows.

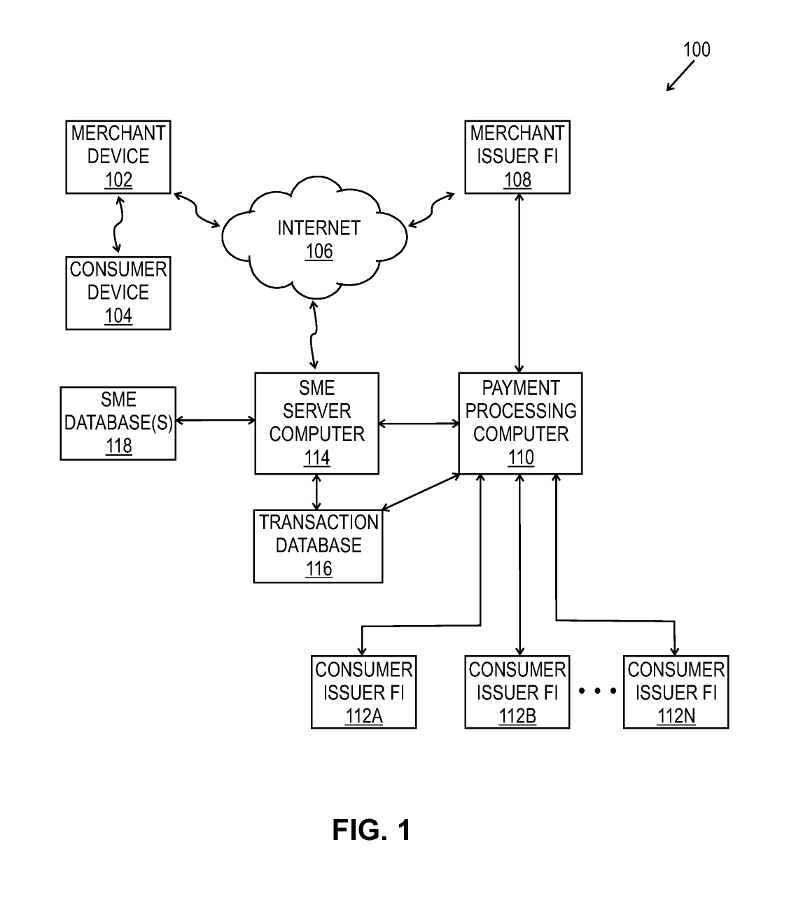

FIG. 1 is a block diagram of an SME system 100 according to an embodiment that includes components configured to operate in accordance with aspects of the processes described herein. It should be understood that the various components shown in FIG. 1 may be a subset of a larger system for providing SMEs with business services to, for example, facilitate electronic purchase transactions via credit card accounts, debit card accounts, reward card accounts, other types of financial accounts and the like. In addition, in some embodiments the SME system 100 is configured for use in a developed market and provides SMEs with business data that can help them understand their customers, manage inventory, manage cash flow, increase sales, purchase supplies, cut costs, adapt to consumer preferences, and/or otherwise improve their small to medium size business in various ways. It should also be understood that, in some embodiments, merchants or owners of SMEs and/or merchant issuer FIs may be required to enroll or register with, for example, a payment processing network and/or an SME server computer in order to utilize the SME applications and obtain the benefits of the SME business processes described herein.

Referring to the SME system 100 of FIG. 1, the merchant device 102 may be, for example, a POS terminal or a merchant's mobile device (such as a suitably programmed mobile telephone, or a personal digital assistant (PDA) with communication capabilities, or a tablet computer with communications capabilities). A consumer may be prepared to pay for a transaction with the merchant by using a payment enabled mobile device 104, which may be a payment enabled mobile telephone, tablet computer, personal digital assistant (PDA) and/or digital music player device. For example, the consumer device 104 may be a payment enabled mobile telephone capable of initiating payment transactions in a payment card system. It should be understood, however, that the consumer may wish to pay by using other forms of payment, for example, by utilizing a traditional credit card or a debit card (not shown) associated with a payment card account, or by using cash. If the SME's merchant device 102 is a POS terminal, such as a cash register in a retail store location, it may be configured to operate for the most part in a conventional manner, and it may have the capability to be programmed to function in accordance with one or more processes described herein. Such a POS terminal 102 may, for example, be found in a small or medium-sized business establishment of an SME, and can be configured to transmit data such as a merchant identifier, purchase transaction information, and other data to a merchant issuer FI 108 via a network such as the internet 106. For example, in some embodiments, when the POS terminal transmits 102 payment transaction data to the merchant issuer FI 108, it also automatically updates an inventory management system. If the SME's merchant device is a mobile device, such as a smartphone or tablet computer or laptop computer, it may also be configured to operate for the most part in a conventional manner, and be configured to be programmed to function in accordance with one or more processes described herein. For example, a micro-business owner may utilize a smartphone to accept electronic payments, track inventory, and to obtain and view customer analytical data, as described herein.

Referring again to the SME system 100 of FIG. 1, the merchant issuer FI 108 is configured for communications with a payment processing computer system 110 (or payment network), which is configured for communicating with a plurality of consumer issuer FIs 112a, 112b to 112n, which are utilized to process consumer purchase transactions. The merchant device 102 and merchant issuer FI 108 may be configured to wirelessly transmit and receive information and/or data via the internet 106, or may be configured to transmit data through a wired connection, or through another type of secured or unsecured network (not shown). For example, in the embodiment of FIG. 1, the merchant device 102 is configured to wirelessly communicate via the internet 106 with the merchant issuer FI 108, but other networks could be utilized (for example, a network operated by a mobile network operator (MNO), not shown, may be interposed between the merchant device 102 and the merchant issuer FI 108). In addition, the merchant issuer FI 108 may be configured for wired communications with one or more other components, such as the payment processing computer 110. One skilled in the art would understand that many different types of secured or unsecured network connections could be utilized, which may be based on the sensitivity of data being processed and/or communicated, and the like. In addition, for ease of understanding, the SME system 100 generally shows only components that are involved in providing SME business services and for handling one purchase transaction, but in practice many more devices representing, for example, a plurality of merchant devices and merchant issuer FIs may be included.

In some embodiments, an owner of an SME may use his or her merchant device 102 to register for SME services, which may include an SME financial account (such as a business debit card account and/or a business credit card account) and an SME platform by initially providing information to a merchant issuer FI 108. In some implementations, the merchant issuer FI 108 is affiliated with a payment processor (such as MasterCard International Incorporated) that operates the payment processing computer system 110. Upon receipt of the registration information provided by the merchant, the merchant issuer FI 108 may perform a background check and/or a credit check, for example, and if all is in order, issue an SME financial account such as an SME business debit card and provide SME services to the SME owner (the merchant), as explained herein. The payment processing computer 110 may receive the SME information and/or merchant identification information and transmit some or all of that information to an SME server computer 114. The SME server computer 114 may be configured to provide SME business applications to the merchant device 102 via the payment processing computer 110 and merchant issuer FI 108. But in some implementations, the SME server computer 114 may be configured to communicate directly with the merchant device 102 associated with the SME via the internet 106 or some other network connection (not shown). The SME server computer 114 is also configured for utilizing data in a transactions database 116 (which is also configured for communications with the payment processing computer 110) and other SME database(s) 118 to provide, for example, business analytics data to the merchant device 102 for use by the SME owner to improve business operations. In some implementations the payment processing computer 110 and SME server computer 114 may be separate computers or computer systems (as shown in FIG. 1), or may be components of a single computer or computer system.

In some embodiments, the merchant issuer FI 108 may offer two or more different types of SME business services, which each may include services targeted to different types of market environments. For example, a “Premier” SME platform may include services suitable for use by SMEs operating in developed markets, whereas a “Basic” SME platform may be configured for use by SMEs operating in developing markets. Some common business services may be part of both the Premier and Basic SME platform packages, whereas one or more business services may be exclusive to a particular SME platform package. For example, both packages may include a low-cost cash register application, but only the “Premier” SME platform may include an online marketplace business application for SMEs in developed markets. Accordingly, in order to accommodate SMEs in developing markets (which have different credit-related and functional characteristics and/or considerations) another implementation of an SME system that is somewhat different from the SME system 100 of FIG. 1 may be used. Such a modified SME system will be described below in accordance with some other embodiments.

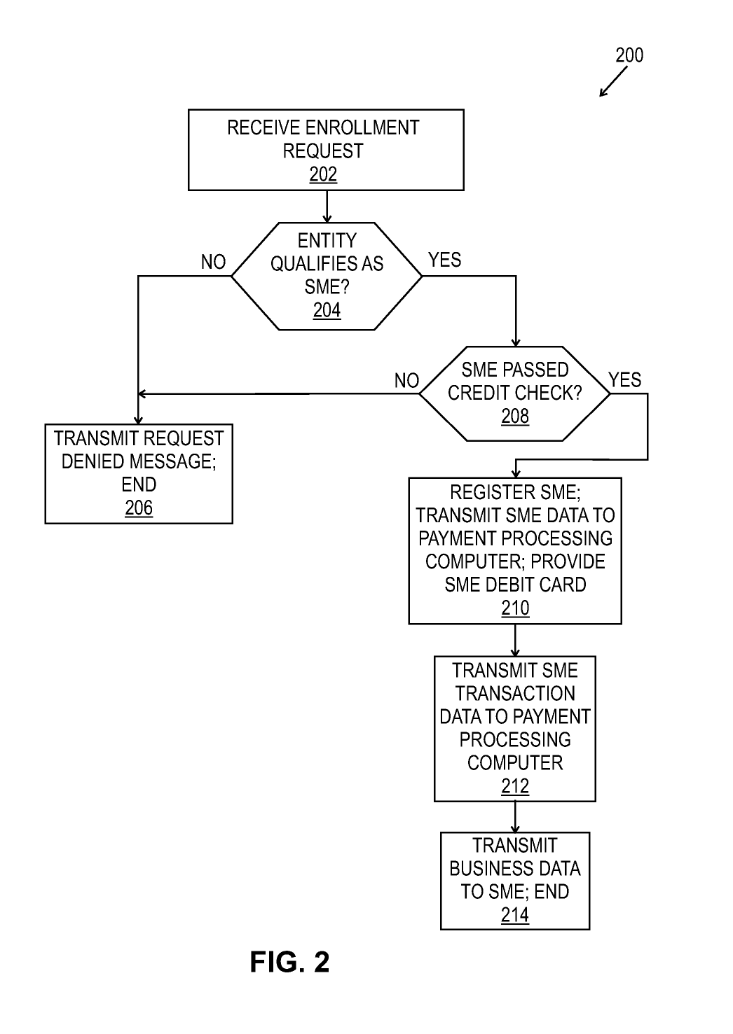

FIG. 2 is a flowchart illustrating an SME registration process according to some embodiments. A merchant issuer FI receives 202 an enrollment request from a merchant claiming to be an SME, which includes merchant identification data. The SME data or merchant identification data may include information such as the name of the business, a business address, and tax identification information (which may be the same process for a business to open, for example, a checking account with a bank). The merchant issuer FI may then conduct a background check and/or due diligence on the SME based on the SME data that was provided. In step 204, if the enrollment request is from an entity that does not qualify as an SME, then the merchant issuer FI transmits 206 an enrollment request denied message and the process ends. If the enrollment request is from an entity that does qualify as an SME, then the process advances to step 208 wherein the merchant issuer FI may perform validation and credit checks concerning the SME and or the merchant (owner of the SME). Such validation and credit checks may include authenticating the identity of the merchant or owner of the SME, and checking the financial records of the SME's business. If the SME fails either of the validation check or the credit check, then the process branches to step 206 wherein the merchant issuer FI transmits an enrollment request denied message and the process ends. But if the SME passes the validation and credit checks, then the merchant issuer FI registers 210 the SME, transmits the SME data to the payment processing network, and provides an SME financial account (such as a business debit card account that is affiliated with the operator of the payment processing network) to the merchant or owner of the SME. It should be understood that such an SME financial account may be a business debit card, for example, that is mailed or otherwise delivered to the merchant. In addition, the SME financial account may have a debit limit and/or credit limit determined by the merchant issuer FI based on information obtained from the merchant and/or obtained from other sources concerning the financial standing of the merchant. Furthermore, such debit and/or credit limits may also be regulated or subject to rules and regulations enforced by a government financial regulator and/or by some other government entity.

Referring again to FIG. 2, the merchant issuer FI is also configured to transmit 212 SME purchase transaction data (for example, customer payment card account data and transaction amount data concerning with a purchase of goods or services from the SME) to the payment processing computer system. In some embodiments, the merchant issuer FI transmits an SME business platform to the merchant device 102 that includes one or more business applications configured for running on the merchant device (which may have been provided to the merchant issuer FI by the payment processing computer via the SME server computer, for example). Such an SME business platform may be based on information provided by the SME during the registration process, and may include business applications and/or components based on the needs and/or requirements of the particular SME. For example, if the SME is using a merchant device that is an “Android” device, then a “cash register” module configured for that type of device (configured to run on the Android operating system) would be included in the SME business platform transmitted by the merchant issuer FI. Other applications contained in the SME business platform may include, for example, a low cost payment card account acceptance service, and business services and analytics (which are discussed in more detail below). In addition, the merchant issuer FI may be configured to transmit 214 business data to the SME (for display, for example, on the merchant device), which may include information related to customer trends, business analytics and/or other data. Such business data may be transmitted on a periodic basis, or may be transmitted on demand in response to a request from the SME (for example, the and SME server computer may transmit business analytics to a merchant device of the SME in response to an analytics request message (on demand) from that merchant device).

As mentioned above, if an SME operating in a developed market successfully enrolls for SME services with a merchant issuer FI, then the SME may receive a “premier” SME platform either from the merchant issuer FI, or from an SME server computer, or from another entity. Such a premier SME platform may be offered and maintained by a payment services provider that operates, for example, a payment computer network 110 in an SME system 100 such as that shown in FIG. 1. As mentioned above, the SME server computer 114 may provide such a premier SME platform to an SME via the internet 106, for example, and the premier SME platform may include one or more of a cash register application, an inventory management application, a cash-flow accounting application, an offer management application, a business analytics application, and/or an online marketplace application. For example, a “cash register” module may be configured to record consumer purchases that occur by cash or by payment card, and may provide receipts to the SME by e-mail and/or text message. Such a cash register module is configured to operate on one or more devices specified by the SME, and in some embodiments includes cash flow accounting features that enable the SME to track sales of merchandise and to conduct business planning An “inventory management” module may also be included that allows the SME to track pricing, inventory, sales and other profit and loss items. Also provided is a low cost “payment card acceptance” module that supports the device(s) and/or types of payments accepted as specified by the SME. For example, the payment acceptance module is configured to support one or more point of sale devices as specified by the SME, or supports a website (for example, a click and drag-type checkout button may be provided that enables simplified payment card account acceptance), or supports an e-mail application (for example, a website that allows merchants to login and generate an invoice with a payment request to any e-mail address or identifier), or supports contactless payments using mobile devices (for example, mobile devices using near-field communications (NFC) or Bluetooth communications processing). Also provided is a “Cash Register Reconciliation” module configured to aid the SME in tracking and reconciling receipts with the money placed in a cash register during business operations. The cash register reconciliation module may be designed to ensure that an SME has the discipline to put receipts into their cash register so that the merchant can keep track of and analyze their business operations.

In some embodiments, the premier SME platform also includes an online marketplace application that allows the SME to obtain potentially better deals for business supplies. For example, a coffee shop merchant selling sandwiches and burgers in Singapore may receive an alert (for example, via SMS message, e-mail, or the like) regarding flash sales (for example, a one-day sale) for microwave convection ovens offered by one or more sellers (for example, by Amazon.com). Furthermore, the merchant may be informed that his or her SME business is eligible for a discount if the merchant utilizes the SME debit card to buy the business item.

In addition, in some implementations of the premier SME platform, an offers management and business analytics module may be provided by the operator of the payment network (for example, by MasterCard International Incorporated). Such an offers management and business analytics module may include an attractive and/or intuitive interface for the SME merchant that helps the merchant understand the types of customers frequenting their retail store and/or website. The module may also perform business functions such as tracking how well some special offers concerning the SME are performing (for example, how many new customers were attracted by a “Groupon” offer).

The premier SME platform provides an end-to-end business solution for an SME in a developed market by providing electronic tools for the SME's business processes. In a retail store example, a small coffee shop business owned by Mr. Lee is called Take-A-Break and is located in the vicinity of a University in Singapore. Take-A-Break offers fresh coffee and tea plus home-made meals and cakes to customers. The menu includes mouth-watering burgers (chicken, veggie, fish and beef), steak sandwiches, hot dogs, lasagna, quiche, a variety of fresh salads, and the like. Take-A-Break has revenue of about $40,000 U.S. dollars a year, and Mr. Lee wants to grow his coffee shop business and open at least five more stores over the next three years. Currently, Take-A-Break accepts only cash or checks from customers even though most of his customers, who are mostly university students, prefer to pay credit card or debit card.

Thus, Mr. Lee is losing some revenue, and is suffering from some accounting issues due to lost payments and missing receipts. Moreover, Mr. Lee must spend time going to his bank to deposit cash and checks.

Mr. Lee finds out that his bank is offering a small business package that includes a small business financial account (an SME business debit card) and an SME platform of business applications, so he opens a bank account and is provided with an instantly-issued SME business debit card. A bank representative asks Mr. Lee what options he would like to have with his Premier SME business platform, including which smart device applications he desires (wherein the business applications are configured to run, for example, on an Apple® iOS and/or Android operating system (OS) and/or a Microsoft® OS). Mr. Lee selects the business applications that he believes will be useful and then installs the SME platform applications on his tablet computer and creates an SME account. After logging in to his SME account, he is able to create inventory, assign pricing to products, add customer information, add vendor information, and the like. When one of Mr. Lee's customers now wishes to pay for a food item via credit card, Mr. Lee can use an SME card reader application to accept credit card payments that are directly deposited to his bank account. Mr. Lee can also now obtain cash from any automated teller machine (ATM).

In some embodiments, the Premier SME platform's online marketplace application running on Mr. Lee's tablet computer informs him that an oven for his coffee shop is on sale by an internet merchant for a bargain price that is fifty percent off (50% off) the retail price. The online marketplace application can also be customized and/or configured by Mr. Lee to provide information regarding other types of business items that he may need or desire for the Take-A-Break business. In this manner Mr. Lee can save money on business purchases. In addition, an offers management application running on Mr. Lee's tablet computer can send special offers to customers of Take-A-Break to increase foot traffic during off-hours and/or to prompt purchases of other items to increase sales. As sales grow and Mr. Lee increases activities with his bank, Mr. Lee receives an increase in his line of credit that allows him to hire more staff and also to expand his business by opening more stores in Singapore. Thus, the SME business applications provided to Mr. Lee by the Premier SME platform help Mr. Lee to save money and to increase revenues so that he can reach his goals concerning growing and/or expanding his business.

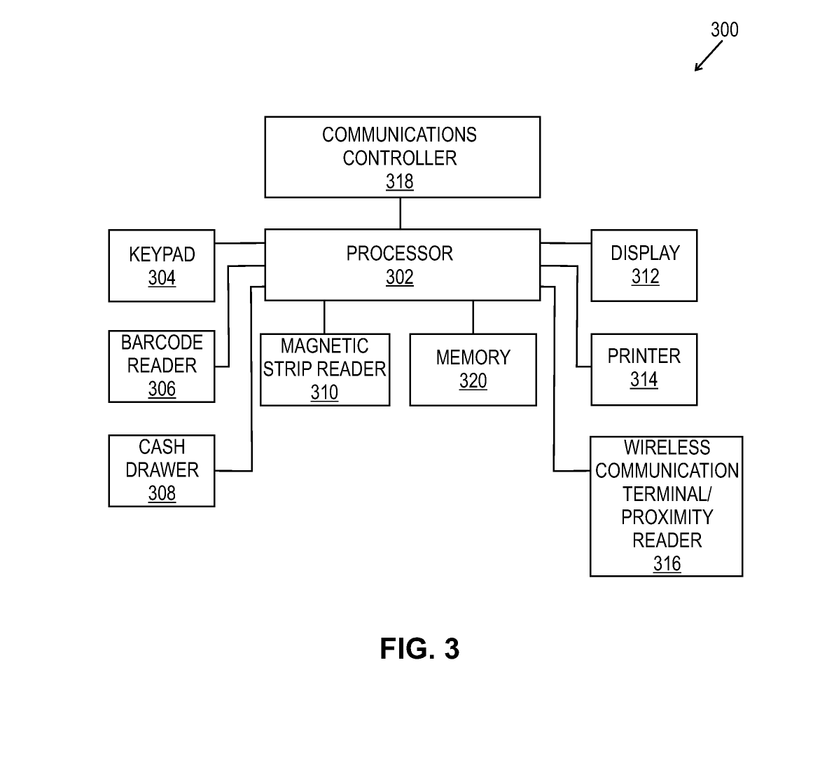

FIG. 3 is a block diagram of a POS terminal 300 for serving (in some embodiments) as the merchant device 102 shown in FIG. 1. In some embodiments, the POS terminal 300 may be largely or entirely conventional in its hardware aspects. Nevertheless, the POS terminal may be programmed to provide functionality as described herein.

The POS terminal may include a processing element (or elements) such as the processor 302 shown in FIG. 3. The processor 302 may for example be a conventional microprocessor, and may operate to control the overall functioning of the POS terminal 300. The POS terminal may also include conventional peripheral components, in communication with and/or controlled by the processor 302. Such components may include a keypad 304 for receiving input from a human operator of the POS terminal, a barcode reader 306 for reading product barcodes from products brought to the terminal for purchase, a cash drawer 308 for storing cash received from customers, a magnetic stripe reader 310 for reading payment card account numbers and related information from magnetic stripe payment cards, one or more displays 312 for providing output (e.g., identifying products presented for purchase and their prices, indicating sales tax due, indicating transaction subtotals and totals, etc.), a printer 314 for printing out sales receipts, a wireless communication terminal/proximity reader 316 for exchanging wireless short range communications/near field communications (NFC) with the consumer's mobile device, for example, a smartphone equipped with contactless payment device capabilities, and a communication controller 318 for allowing the processor 302, and hence the POS terminal 300, to engage in communication over the internet 106 or over other data networks with other devices such as the SME server computer 114 or the merchant issuer FI computer 108 (shown in FIG. 1).

In some embodiments, at least one of the displays 312 may be a touch screen, so as to provide an input function as well as an output function. In some embodiments, the communication controller, or another communication device coupled to the processor 302, may be provided to allow the POS terminal 300 to transmit and receive text messages or the like via a mobile telephone network (not shown). In addition, the POS terminal 300 may include one or more memory and/or data storage devices (indicated collectively at 320), which may comprise any combination of one or more of a hard disk drive, RAM (random access memory), ROM (read only memory), flash memory, and the like. The memory and/or data storage device(s) 320 may store software and/or firmware that programs or instructs the processor 302 and thus the POS terminal 300 to perform functions and/or include functionality and/or operate as described herein. For example, in some implementations the POS terminal 300 automatically updates the inventory management system for each payment received. Further, the POS terminal 300 may include one or more housings (not shown) that contain and/or support one or more of the other components shown in FIG. 3. One skilled in the art will recognize that components such as the magnetic card reader 310 and/or the wireless communication terminal/proximity reader 316 may be integrated in a single unit, and may include a display and/or touch screen to allow for user interaction (for example, input from a cashier). The POS terminal 300 shown in FIG. 3 may be used the SME merchant or employee to conduct purchase transactions, request and view data concerning business analytics, customer trends, and/or other data. The POS terminal 300 may also be configured to periodically transmit business data and/or receive business information.

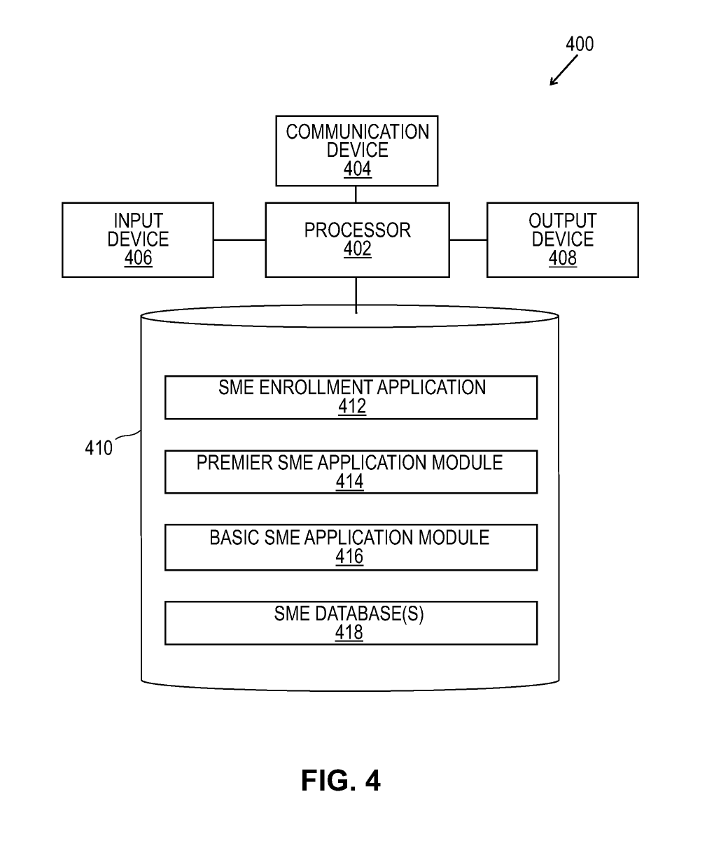

FIG. 4 is a block diagram illustrating an SME server computer 400 according to an embodiment. A computer processor 402 is operatively coupled to a communication device 404, an input device 406, an output device 408, and a storage device 410.

The computer processor 402 may be constituted by one or more conventional processors. Processor 402 operates to execute processor-executable steps, contained in program instructions described below, so as to control the smart preferences computer 400 to provide desired functionality.

Communication device 404 may be used to facilitate communication with, for example, other devices (such as the payment processing computer 110, and merchant devices via the internet as shown in FIG. 1). Communication device 404 may, for example, have capabilities for sending and receiving messages via the internet, over mobile telephone networks, and/or engaging in data communication over conventional computer-to-computer data networks.

Input device 406 may comprise one or more of any type of peripheral device typically used to input data into a computer. For example, the input device 406 may include a keyboard and a mouse. Output device 408 may comprise, for example, a display and/or a printer.

Storage device 410 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory. Thus, the storage device 410 is a non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

Storage device 410 stores one or more programs or applications for controlling the processor 402. The programs comprise program instructions that contain processor-executable process steps of the SME server computer 400, including, in some cases, process steps that constitute processes provided in accordance with principles of the present disclosure, as described herein.

The programs stored by the storage device may include an SME enrollment application 412 that manages a process by which merchants and/or owners of small to medium size businesses may register or enroll themselves and/or their merchant devices with the SME server computer 400. In some embodiments, the SME enrollment process may allow merchant/owners of small businesses to enroll themselves by accessing, via their merchant devices, a suitable web page hosted by the SME server computer 400. In some other embodiments, the SME enrollment process may be accessed and/or utilized by merchant issuer FIs 108 to enroll customers (merchants) to obtain SME services. The information obtained from a merchant during the enrollment process may include business identification data such as a name and address, an SME payment card account number, one or more mobile device identifiers (such as a mobile telephone number), and/or other information concerning the merchant. The enrollment process may also require the merchant to select a PIN (personal identification number) or other identifier to be used for security purposes in connection with data requests initiated by the merchant via his/her merchant device. Other security measures may also be put in place, including industry-standard security processes and/or procedures. The SME server computer may cooperate with the merchant issuer FI 108 and or the payment processing computer 110 to implement security measures that assure that the individual merchant (SME owner) enrolling with, or otherwise accessing, the SME server computer 400 is not an impostor.

The storage device 410 may also store a premier SME platform application module 414 for use by enrolled SMEs that are operating in a developed market. In some embodiments, the premier SME platform application module 414 is transmitted to merchant issuer FIs 108 for distribution to merchant devices 102 operated by the owners (merchants) of SMEs, whereas in other implementations, the SME server computer 400 is configured to directly transmit the premier SME platform application module to merchant devices of enrolled SMEs. The premier SME platform application module may include, for example, a cash register application, an inventory management application, a cash-flow accounting application, an offer management application, a business analytics application, and/or an online marketplace application.

The storage device 410 may also store a basic SME platform application module 416 for use by enrolled SMEs that are operating in developing markets. The basic SME platform application module may be transmitted directly by the SME server computer 400 to merchant devices of such SMEs, or may be provided to one or more mobile network operators (MNOs), or to social service entities or global aid agencies (which will be discussed below) for distribution to the SMEs in developing markets. The basic SME platform application module may include, for example, a cash register application, a simple inventory management application, a low cost payment acceptance application, a bill payment application, an air-time top-up application, a card issuance/linking application, and/or an agent cash-in/cash-out application.

In addition, the storage device 410 may store one or more databases 418 that are maintained by the SME server computer 400. Among these databases may be, for example, a consumer information database, a business trends database, a business offers database, and a consumer trends database. The SME server computer 400 may be operable to obtain data to populate such databases directly from participating merchant issuer FIs and/or enrolled SMEs. The application programs of the SME server computer 400 may be combined in some embodiments, as convenient, into one, two or more application programs. Moreover, the storage device 410 may store other programs, such as one or more operating systems, device drivers, database management software, web hosting software, and the like.

The descriptions provided above have focused on SMEs (small and/or medium sized businesses) operating in a developed market, and thus the premier SME business platform is designed to function in the context of a four-party model. In particular, in developed markets the current relationship framework includes merchants (owners of SMEs), merchant issuer FIs, a payment processing network (such as Banknet™ which owned and operated by MasterCard International Incorporated), and customer issuer FIs. However, such infrastructure does not typically exist in developing markets, and thus alternate partnerships must be formed to provide an SME platform to small and medium sized businesses. In some embodiments, social service entities and/or mobile telephone companies may be utilized as payment facilitators, and global aid agencies and/or government offices may be utilized as program managers to ensure the success of the program. A payment processing operator (such as MasterCard International Incorporated) will need to work closely with merchant issuer FIs to take the value proposition to the small and medium businesses in the developing markets. In addition, in developing markets, providing premier-type SME platform applications is typically not possible due to a fractured marketplace, poor to non-existent infrastructure, and unfavorable and/or strict government regulations of financial institutions (such as banks). Thus, in some embodiments a “basic” SME platform is provided to SME's who enroll to receive an SME services package.

Accordingly, if an SME operating in a developing market enrolls and is accepted for SME services with a merchant issuer FI, then is some embodiments the SME receives a “basic” SME platform from the merchant issuer FI. The basic SME platform may also be created by a payment services provider that operates a payment network, and may include one or more of a low-cost payment card acceptance application, a cash register application to record purchases, an inventory management application, a bill payment application, an airtime “top-up” application, a cash-flow accounting application, a card issuance/linking application, and an “agent cash-in/cash-out” application. For example, a “cash register” module may be configured to record consumer purchases that occur by cash or by payment card, and may provide receipts to the merchant device of the small or medium business by e-mail and/or text message. Such a cash register module is configured to operate on one or more merchant devices specified by the SME, and in some embodiments may include a cash flow accounting feature that enables the merchant owner of the SME to track sales of merchandise and to conduct business planning A simple “inventory management” module may also be included that allows the merchant to track pricing, inventory, sales and other profit and loss items. In some implementations, a low cost “payment card acceptance” module is also provided that supports the device(s) and/or types of payments accepted as specified by the merchant (the SME owner). For example, the payment acceptance module is configured to support one or more point of sale devices, or supports contactless payment card payments, or supports mobile money payments using a mobile device such as a smartphone. In some implementations, a bill payment module is provided that helps the merchant to pay utility bills electronically using their SME debit card on behalf of walk-in customers, wherein the walk-in customers provide cash or a payment card account number to the merchant to pay the customer's bills. This merchant service ensures that the customer does not have to mail a check or stand in a long queue in order to pay one or more of his or her bills. In a developing market, providing such a customer service may help a merchant to increase foot traffic to the merchant's retail location and thus to increase sales of items and/or other services.

In some embodiments, the basic SME platform includes an “Airtime Top-up” module to help the SME electronically load prepaid airtime minutes to mobile devices of their customers. This airtime top-up module reduces SME issues that may arise concerning inventory management and promotions, and provides the SME with the ability to offer lower prepaid airtime denominations (which is an issue, for example, for SMEs that offer scratch cards used for airtime top-up). In addition, a “Card Issuance/Linking” module may be provided that allows consumers to use SME locations to issue a companion prepaid card linked to their mobile money wallets. Local regulations typically vary from market to market concerning allowing an SME to act as a business correspondent of the issuer, and thus such a card issuance/linking module may be configured to conform to the local regulations. Moreover, some embodiments of the basic SME platform include an “Agent Cash in/Cash Out” module that permits merchants to use their store locations to transfer money in and out of their mobile money wallets. In some implementations, the SME debit card is used to facilitate such cash in and cash out transactions, and can be configured to conform to local regulations of the market in which such transactions occur.

Thus, with regard to the SME platforms discussed herein, merchants benefit by using the small business applications to increase revenue, to save money on business costs by following supply purchase recommendations, to improve day-to-day business operations by following operational recommendations, and to improve performance tracking that can be used to expand the business. In developed markets, merchant issuer FI's who offer the SME platform benefit by obtaining a new merchant base (small and medium size business owners), by increasing their transaction revenue resulting from SME purchases and settlements, by increasing merchant subscription fees, and by increasing their deposit float (which can be used for investment purposes). The merchant issuer FIs also are providing a “sticky” business management solution for their SME customers (i.e., a business solution that merchants come to rely upon and do not wish to replace). Such a “sticky” business management solution permits the merchant issuer FI to cross-sell additional financial products to merchants already enrolled in the SME service platform. In addition, a payment services processing entity (or payment network provider) benefits by increasing revenue through increased transaction volume from the merchant/owners of the SMEs; by providing a low cost acceptance package (a bundled service that includes an SME debit card as an issuance product); by obtaining access to SME data that can be mined and used to generate and provide additional business offers, build loyalty and cross-sell other business products; by providing small business performance data to the merchant issuer FIs to drive customer relationship value; and by providing early electronic payment education to SMEs (especially in developing markets) to encourage these small and medium size businesses to adopt credit card payments.

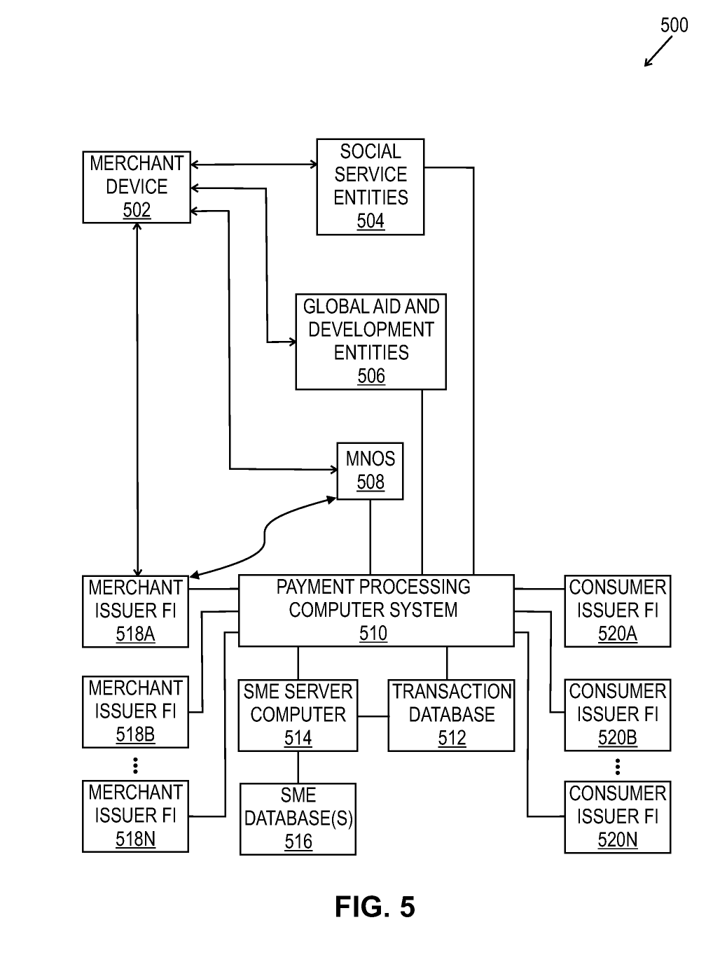

FIG. 5 is a block diagram illustrating a developing market small and medium enterprise (SME) processing system 500 according to an embodiment of the disclosure, and includes components configured to operate in accordance with aspects of the processes described herein. It should be understood that the various components shown in FIG. 5 may be a subset of a larger system for providing SMEs in developing markets with business services to facilitate electronic purchase transactions via credit card accounts, debit card accounts, reward card accounts, other types of financial accounts and the like. In addition, each of the blocks depicted in FIG. 5 may include one or more processors, computers and/or computer systems configured for communications with each other as shown.

Referring to FIG. 5, merchants in developing markets who own and operate small to medium sized businesses typically utilized a merchant device 502 that is a mobile device, such as a mobile telephone, tablet computer or laptop computer. In some developing markets, payment facilitators such as social service entities 504, global aid and development entities 506 and/or mobile network operators (MNOs) 508 are utilized to promote and/or advertise the small business platform services, and one or more or each of them may act as a middleman between the small to medium business merchants and a payment processing computer system 510. In particular, a payment facilitator operates to interface with and to manage relatively smaller merchants that financial institutions such as banks may be unwilling to underwrite or provide with payment processing services. A payment facilitator may function in to take on merchant risk, and/or can act as a pure reseller and processor of an acquirer's merchant services. It should be understood that, with reference to FIG. 5, each of the boxes 504, 506 and 508 may represent one or more payment facilitator computers or payment facilitator computer systems (for example, server computers) or computer system networks configured for communicating with merchant devices 502 and/or other components of the system 500 (such as other computers and computer systems) either wirelessly or via wired connections and/or over network connections to receive, transmit and process data in accordance with the processes described herein.

Thus, in some embodiments merchants of SMEs operating in developing markets may be able to enroll or register for an SME business platform by utilizing a merchant device to contact a payment facilitator computer (such as a social services entity computer 504, a global aid and development entity computer 506 and/or an MNO computer 508). For example, a merchant operator of an SME may utilize his merchant device 502 to contact his MNO 508 to request basic SME business platform services. The MNO 508 would obtain and process merchant enrollment data to validate the merchant as being qualified as an SME, and then contact the payment processing computer system 510. In such case, a payment services provider that operates the payment processing computer system 510 may then communicate with an SME server computer 514 and one or more merchant issuer FI computers, 518A, 518B to 518N to arrange to provide one or more of a low-cost payment card acceptance application, a cash register application to record purchases, an inventory management application, a bill payment application, an airtime “top-up” application, a cash-flow accounting application, a card issuance/linking application, and an “agent cash-in/cash-out” application to the merchant device 502. In addition, one of the merchant issuer FIs 518A-518N may issue an SME financial account (such as a business debit card account and/or a business credit card account) to the merchant/owner of the SME. The spending limits and/or credit limits on such business debit card accounts and/or business credit card accounts may be determined by the particular merchant issuer FI and/or may be subject to or set by government regulations, for example, by the government in the country of residence of the merchant. Referring again to FIG. 5, the SME server computer 514 is also in communication with one or more SME databases 516 and a transaction database 512, which contain data that may be useful in developing one or more small to medium business service applications and/or for supporting the business applications provided to the merchant/owner of the SME.

In developing markets, a consumer may be prepared to pay for a transaction with the merchant or owner of an SME by using a payment enabled mobile device such as a payment enabled mobile telephone, tablet computer, personal digital assistant (PDA) and/or digital music player device, or may wish to pay by using other forms of payment, for example, by utilizing a credit card or a debit card associated with a payment card account, or by using cash. Thus, the SME's merchant device 502 is provided with an application so as to function as a payment acceptance terminal in accordance with one or more processes described herein. For example, a small business owner may utilize a smartphone to accept electronic payments as well as to track inventory, and to perform bill payment services for customers.

Referring again to the SME system 500 of FIG. 5, the payment processing computer system 510 (or payment network) is also configured for communicating with a plurality of consumer issuer FIs 520A, 520B to 520Nn, which are utilized to process consumer purchase transactions. In some embodiments, the merchant device 502 and merchant issuer FI 518A, for example, may be configured to wirelessly transmit and receive information and/or data via a network such as the internet (not shown), or may be configured to transmit data through the MNO 508, or via a wired connection, or through another type of secured or unsecured network (not shown). One skilled in the art would understand that many different types of secured or unsecured network connections could be utilized, which may be based on the sensitivity of data being processed and/or the available network infrastructure, and the like. In addition, for ease of understanding, the SME system 500 generally shows only components that are involved in providing SME business services and for handling one purchase transaction in developing markets, but in practice many more devices representing various components may be included.

The flow charts and descriptions thereof herein should not be understood to prescribe a fixed order of performing the method steps described therein. Rather the method steps may be performed in any order that is practicable.

As used herein and in the appended claims, the term “payment card account” includes a credit card account or a deposit account that the account holder may access using a debit card or a gift card account. The term “payment card account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card) or a gift card. The term “payment card account” also includes an account to which a payment card account number is assigned. Thus a payment card account may include an account to which payment transactions may be routed by a payment system that handles debit card and/or credit card and/or gift card transactions, even if the account in question is not eligible to be charged for purchase transactions or other transactions. A payment card account may also include an account from which payment transactions may be routed by a payment system that handles debit card and/or credit card and/or gift card transactions, even if the account in question is not customarily used, or is not eligible, to be charged for purchase transactions.

Although the present specification describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a request for a small to medium enterprise (SME) business platform, wherein the request includes merchant identification data of a merchant;
validating the merchant identification data;
providing an SME financial account to the merchant;
transmitting, by a processor to a merchant device of the merchant, an SME business platform acceptance message; and
transmitting, by the processor an SME business platform to the merchant device, wherein the SME business platform comprises a payment card account acceptance application and at least one business services application configured for running on the merchant device.

2. The method of claim 1, wherein the merchant identification data comprises at least two of a name of the business, a business address, and tax identification information.

3. The method of claim 1, wherein validating the merchant identification data comprises:
determining that the merchant qualifies as an SME; and
determining that the merchant passed a credit check based on business financial records of the merchant.

4. The method of claim 3, wherein the merchant qualifies as an SME when the merchant identification data indicates that the merchant operates one of a micro-business, a small business or a medium size business.

5. The method of claim 1, further comprising, prior to validating the merchant identification information:
determining, based on the merchant identification data, at least one of that the merchant does not qualify as an SME and the merchant failed a credit check; and
transmitting, by a processor to the merchant device, an SME business platform request denied message.

6. The method of claim 1, further comprising, periodically transmitting, by the processor, business data to the merchant device.

7. The method of claim 1, further comprising transmitting, by the processor, business data on demand to the merchant device.

8. The method of claim 1, wherein the SME business platform comprises a Premier SME platform module when the request originates from an SME in a developed market, and comprises a Basic SME platform module when the request originates from an SME in a developing market.

9. The method of claim 8, wherein the Premier SME platform module comprises a cash register application, a cash register reconciliation application, an inventory management application, a cash-flow accounting application, a purchasing application, an offers management and business analytics application, and an online marketplace application.

10. The method of claim 8, wherein the Basic SME platform module comprises a payment card account acceptance service, an inventory management application, a cash-flow accounting application, a bill payment application, an airtime top-up application, a card issuance and linking application, and an agent cash-in cash-out application.

11. The method of claim 1, wherein the SME financial account comprises at least one of a business debit card account and a business credit card account.

12. A system comprising:
a merchant device;
a merchant issuer financial institution (FI) computer in communication with the merchant device; and
a payment processing computer system in communication with the merchant issuer FI computer;
wherein the merchant device transmits a request from a merchant for a small to medium enterprise (SME) business platform to the merchant issuer FI computer, the request including merchant identification data of the merchant, and wherein the merchant issuer FI computer validates the merchant identification data, provides an SME financial account to the merchant and transmits an SME business platform acceptance message to the merchant device; and
wherein the payment processing computer system transmits an SME business platform to the merchant device, wherein the SME business platform comprises a payment card account acceptance application and at least one business services application configured for running on the merchant device.

13. The system of claim 12, further comprising an SME server computer in communication with at least one of the payment processing computer system and the merchant device, the SME server computer operable to provide one of a Premier SME business platform or a Basic SME business platform to the merchant device.

14. The system claim 13, wherein SME server computer is operable to generate the Premier SME platform module comprising at least two of a cash register application, a cash register reconciliation application, an inventory management application, a cash-flow accounting application, a purchasing application, an offers management and business analytics application, and an online marketplace application.

15. The system of claim 13, wherein the SME server computer is operable to generate the Basic SME platform module comprising at least two of a payment card account acceptance service, an inventory management application, a cash-flow accounting application, a bill payment application, an airtime top-up application, a card issuance and linking application, and an agent cash-in cash-out application.

16. A method comprising:
receiving, by a payment facilitator computer from a merchant device, a request for a small to medium enterprise (SME) business platform, wherein the request includes merchant identification data of a merchant;
validating, by the payment facilitator computer, the merchant identification data;
transmitting, by the payment facilitator computer to a payment processing computer, the request for the SME business platform and the merchant identification data; and
providing a Basic SME business platform to the merchant device.

17. The method of claim 16, further comprising providing an SME financial account to the merchant.

18. The method of claim 17, wherein the SME financial account comprises at least one of a business debit card account and a business credit card account.

19. The method of claim 16, wherein the merchant identification data comprises at least two of a name of the business, a business address, and tax identification information.

20. The method of claim 16, wherein validating the merchant identification data comprises determining that the merchant qualifies as an SME.

21. The method of claim 20, wherein the merchant qualifies as an SME when the merchant identification data indicates that the merchant operates one of a micro-business, a small business or a medium size business.

22. The method of claim 16, wherein the Basic SME business platform comprises at least two of a payment card acceptance application, a cash register application, an inventory management application, a bill payment application, an airtime top-up application, a cash-flow accounting application, a card issuance/linking application, and an agent cash-in/cash-out application ,

23. A system comprising:
a merchant device;
a payment facilitator computer in communication with the merchant device;
a payment processing computer system in communication with the payment facilitator computer;
at least one merchant issuer financial institution (FI) computer in communication with the payment processing computer system; and
an SME server computer in communication with the payment processor computer system;
wherein the merchant device transmits a request from a merchant for a small to medium enterprise (SME) business platform to the payment facilitator computer, the request including merchant identification data of the merchant,
wherein the payment facilitator computer receives the request for the SME business platform from the merchant device, validates the merchant identification data and transmits the request for the SME business platform and the merchant identification data to the payment processing computer;
wherein the payment processing computer communicates with the SME server computer and the at least one merchant issuer FI computer and arranges to provide a Basic SME business platform to the merchant device; and
wherein the at least one merchant issuer FI computer provides the Basic SME business platform to the merchant device.

24. The system of claim 23, further comprising at least one consumer issuer financial institution (FI) in communication with the payment processing computer system, the consumer issuer FI configured for authorizing consumer purchase information transmitted by the merchant device via the payment facilitator tot the payment processing computer system.

25. The system of claim 23, wherein the SME server computer is operable to generate the Basic SME platform module comprising at least two of a payment card account acceptance service, an inventory management application, a cash-flow accounting application, a bill payment application, an airtime top-up application, a card issuance and linking application, and an agent cash-in cash-out application.

26. The system of claim 23, wherein the merchant issuer FI computer also provides an SME financial account to the merchant.

27. The system of claim 26, wherein the SME financial account comprises at least one of a business debit card account and a business credit card account.
